(19) United States
(12) Patent Application Publication
(10) Pub. No.: US 2026/0220526 A1
(43) Pub. Date: Jul. 30, 2026

(54) EFFICIENT ON-DEVICE MACHINE LEARNING MODEL UPDATES

(71) Applicant: Snap Inc., Santa Monica, CA (US)

(72) Inventors: Nir Malbin, Shoham (IL); Gal Dudovitch, Tel Aviv (IL); Avihay Assouline, Tel Aviv (IL); Itamar Berger, Hod Hasharon (IL)

(21) Appl. No.: 19/039,019

(22) Filed: Jan. 28, 2025

(51) Int. Cl. G06N 20/00

(52) U.S. Cl. CPC G06N 20/00

(57) ABSTRACT

Examples relate to systems and methods for providing a machine learning model on a mobile device. The systems and methods store a base machine learning (ML) model on a user system, the base ML model trained to perform a first task in an individual domain. The systems and methods receive input that selects a second task in the individual domain and access parameter update information associated with the second task. The systems and methods update the base ML model based on the parameter update information associated with the second task and generate an output corresponding to the second task by processing an input by the updated base ML model.

### TECHNICAL FIELD

The present disclosure relates to computer graphics technologies, specifically to generative rendering engines for generating digital effects on user devices.

### BACKGROUND

Some electronics-enabled devices, such as eyewear devices, allow users to interact with virtual content (e.g., augmented reality (AR) objects or other digital effects) while a user is engaged in some activity. The virtual content can be part of a digital effects application that presents such objects over a real-world environment. Current rendering engines for computer graphics rely on physics-based principles, requiring extensive three-dimensional (3D) modeling, animation, and rigging, which is time-consuming and demands multiple experts. This traditional approach limits the ability to create highly realistic images and videos in real-time. Additionally, existing systems often require sophisticated tracking and recognition technology (which itself is imperfect), complicating the creation of realistic content.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of a digital effects experience generation system, according to some examples.

FIG. 6 illustrates an example database, according to some examples.

FIG. 7 is a flowchart illustrating a routine (e.g., a method or process), according to some examples.

FIG. 8 illustrates a system including the head-wearable apparatus, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

On-device machine learning (ML) models have become important for enabling functionality like image classification, processing, and generation directly on user devices. These on-device implementations provide important benefits including enhanced privacy, reduced latency, and decreased network dependencies. However, current approaches to deploying ML models on devices face significant technical challenges and inefficiencies. The primary limitations stem from constraints around storage capacity, cache memory, and bandwidth restrictions, such as when multiple different models need to be supported for performing different tasks.

Conventional systems usually need to send completely new ML model files to devices whenever functionality needs to be modified or updated. These full model deployments are resource intensive, often requiring transmission of files that are 10 megabytes or larger in size. This leads to substantial bandwidth consumption, storage overhead, and cache utilization inefficiencies. Additionally, conventional approaches necessitate maintaining separate complete models for each distinct task or capability, even when there is some overlap in the underlying functionality. This results in redundant storage of shared model components and unnecessary duplication of parameters across multiple models.

The technical problems are pronounced in domains like image manipulation and augmented reality effects, where supporting multiple variations of similar capabilities (like different makeup effects or style transfers) requires deploying numerous large models that share considerable common functionality. This conventional approach of maintaining separate full models for each variation creates significant waste in terms of device resources and network bandwidth. Furthermore, conventional approaches for updating or modifying model behavior involve time-consuming retraining processes that can take many hours to complete. This makes it impractical to efficiently adapt models for new tasks or variations while maintaining reasonable response times and resource utilization.

The disclosed examples improve the efficiency of using the electronic device by providing a system that reduces device storage and bandwidth requirements by maintaining an individual cached base ML model while enabling dynamic task switching through small parameter updates. These small parameter updates can represent less than one percent of the original ML model size. The disclosed examples improve efficiency by eliminating the need to store and transmit completely separate ML models for each task variation, and instead utilize lightweight mobile Low-Rank Adaptation (mLoRA) updates that can be quickly applied to modify the behavior of the individual cached base ML. This approach can reduce computational overhead and resource utilization while maintaining ML model performance, because the disclosed examples intelligently determine the minimal set of parameters that need to be modified when transitioning between tasks within the same domain. The improved efficiency is achieved through a specific training process that optimizes for low-rank weight matrices and enables real-time model adaptation with minimal bandwidth and computational requirements.

Specifically, the disclosed examples store a base ML model on a user system. The base ML model can be trained to perform a first task in an individual domain. The disclosed examples receive input that selects a second task in the individual domain and access parameter update information associated with the second task. The disclosed examples, in response to receiving the input and accessing the parameter update information, update the base ML model based on the parameter update information associated with the second task and generate an output corresponding to the second task by processing an input by the updated base ML model. For example, the disclosed system stores a base ML model trained for applying makeup effects to facial images (images in which a face of a person is depicted). When a user wants to change from applying a peach-colored lipstick effect (first task) to a different makeup effect (second task, such as overlaying zebra stripes on the face), the system receives this selection and accesses the corresponding mLoRA parameter update. The disclosed system then updates the base ML model with the small parameter modifications and processes the facial image to generate the new makeup effect. This enables efficient switching between different makeup effects while maintaining a single cached base ML model locally on the user device.

The disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content presented on a video or image.

### Networked Computing Environment

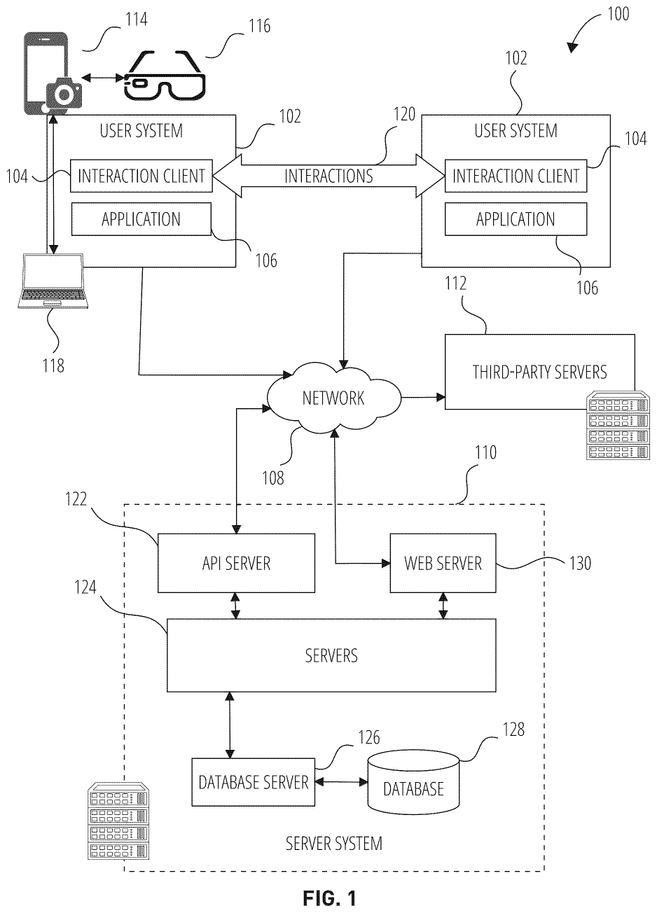

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

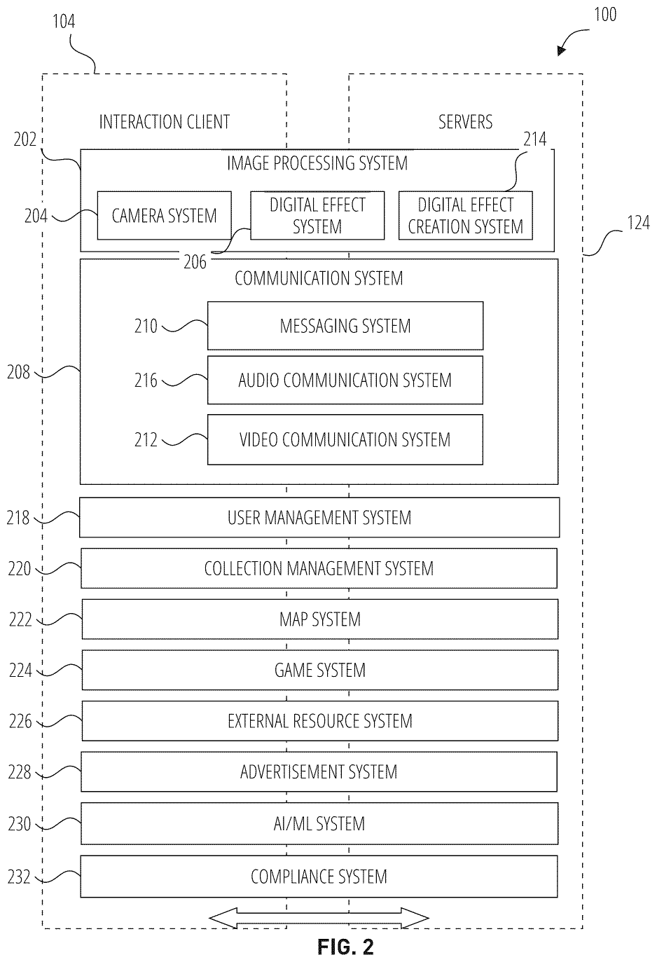

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative machine learning models to generate the digital effects experiences, such as by presenting artificially generated or artificially augmented video with one or more digital effects.

The disclosed examples improve the efficiency of using the electronic device by providing a system that reduces device storage and bandwidth requirements by maintaining an individual cached base ML model while enabling dynamic task switching through small parameter updates. These small parameter updates can represent less than one percent of the original ML model size. The disclosed examples improve efficiency by eliminating the need to store and transmit completely separate ML models for each task variation, and instead utilize lightweight mLoRA updates that can be quickly applied to modify the behavior of the individual cached base ML. This approach can reduce computational overhead and resource utilization while maintaining ML model performance, because the disclosed examples intelligently determine the minimal set of parameters that need to be modified when transitioning between tasks within the same domain. The improved efficiency is achieved through a specific training process that optimizes for low-rank weight matrices and enables real-time model adaptation with minimal bandwidth and computational requirements.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 802 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model. In some cases, the prompts can instruct the generative machine learning model (GenAI) to process an image or video of an avatar along with audio input and to generate a video that depicts the avatar (lips of the avatar) speaking speech provided by the audio input.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100 including a digital effects experience generation system 504, such as a base ML model component 516.

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions.

In some cases, the artificial intelligence and machine learning system 230 can include a first base ML model associated with a first domain and a second base ML model associated with a second domain. The first base ML model can be trained to perform a first set of tasks in the first domain while the second base ML model can be trained to perform a second set of tasks in the second domain. Specifically, for the image manipulation and digital effects domain, the first base ML model can be trained to handle tasks such as applying different makeup effects to facial images, modifying facial features and expressions, changing eye colors, applying style transfers to images, and performing segmentation and modification of clothing items. In the avatar animation and speech processing domain, the second base ML model can support tasks including generating synchronized lip movements for avatar speech, translating speech between different languages while maintaining cultural speaking patterns, transforming speech emotional styles from neutral to humorous, creating multi-avatar group animations with synchronized speech, and enhancing speech patterns by removing pauses and unclear segments. Each domain represents a distinct area of functionality where the base ML model maintains core understanding of the domain-specific features. For example, the image manipulation domain can require understanding facial features and digital effects, while the avatar animation domain focuses on speech-to-animation conversion and linguistic processing. The artificial intelligence and machine learning system 230 can efficiently switch between tasks within each domain using small parameter updates while maintaining the domain-specific base knowledge in the respective ML models.

In some examples, the first base ML model and the second base ML model can be stored/cached on a local user system 102. These can be the general ML models that are trained to perform tasks within their respective domains. In response to receiving input that selects a new task that is not within the first set of tasks of the first base ML model, the local user system 102 can communicate with a remote server to obtain a set of parameter update information (e.g., mLoRA updates) associated with the new task. The user system 102 can then update a small (e.g., less than one percent) subset of parameters of the first base ML model using the obtained set of parameter update information. This results in a fused or updated first base ML model that is now specifically configured and trained to perform the new task within the first domain. Similar operations and functions can be performed to train/configure the second base ML model to perform a newly selected task in the second domain.

For example, in the image manipulation domain of the first base ML model, if a user wants to add a new zebra stripe pattern overlay effect to faces (which was not included among the first set of tasks of the first base ML model), the user system 102 can request the corresponding mLoRA parameter updates from the remote server. The base ML model, which was originally trained for basic makeup effects like lipstick colors, can be efficiently adapted to perform this new zebra pattern overlay task by updating less than one percent of its parameters using the obtained mLoRA updates. The user system 102 processes these small parameter modifications to configure the first base ML model for generating the zebra stripe effect while maintaining the model's fundamental understanding of facial features and digital effects processing. This enables quick deployment of the new creative effect without requiring transmission or storage of a completely new ML model, thereby demonstrating how the user system 102 can efficiently expand its capabilities within the image manipulation domain through targeted parameter updates.

For brand messaging applications, the system maintains consistent corporate communication styles by storing specialized mLoRA updates that capture company-specific speaking patterns and delivery characteristics. The model update component applies these updates to ensure all generated content aligns with established brand standards. In the speech enhancement domain, the base model handles core speech processing capabilities while mLoRA updates enable specific modifications like removing unclear patterns or adjusting emotional tone. The model update component can apply these updates in real-time to improve speech quality while maintaining natural flow.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

The neural network architecture implemented for avatar animation may include specialized components like Generative Adversarial Networks (GANs) that can generate realistic facial animations, and Recurrent Neural Networks (RNNs) that can process the temporal aspects of speech. The model learns to generate smooth, natural-looking animations that accurately reflect the timing and characteristics of the input speech. In the prediction phase, when processing new user speech input, the trained model analyzes the audio features and generates corresponding avatar animations in real-time. The model can handle various speech modifications, including language translation and emotional style changes, by learning correlations between different speech patterns and appropriate animation responses. This enables the system to generate realistic avatar animations without requiring complex tracking or modeling systems. The training process also incorporates techniques for handling different avatar types and customization options. The model learns to adapt the generated animations to different avatar facial structures while maintaining natural movement patterns. This allows the system to work effectively with avatars that have visual features representing the user or their friends, while ensuring consistent and realistic animation quality.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

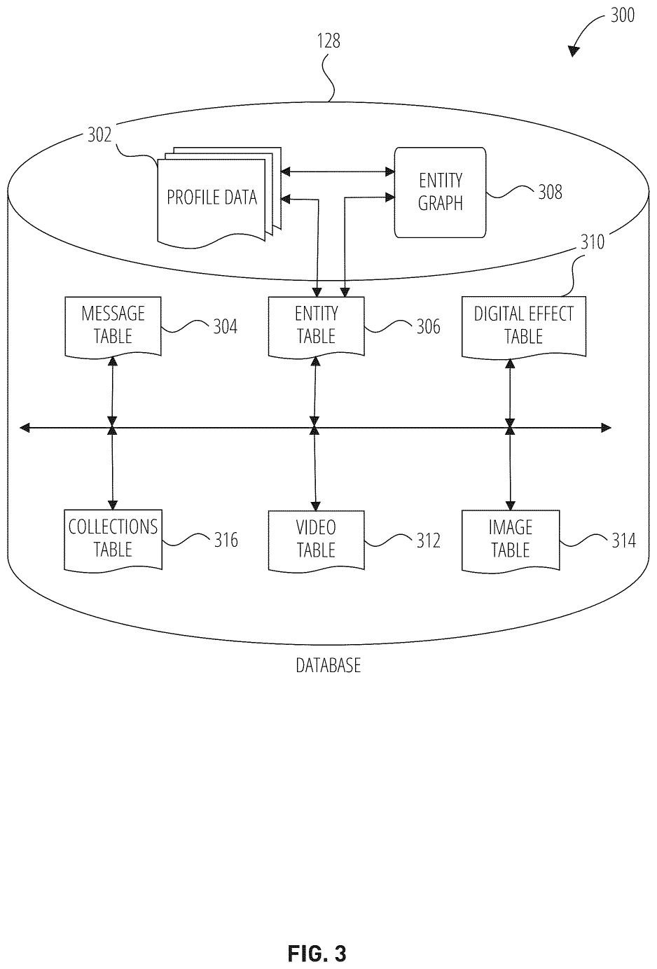

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

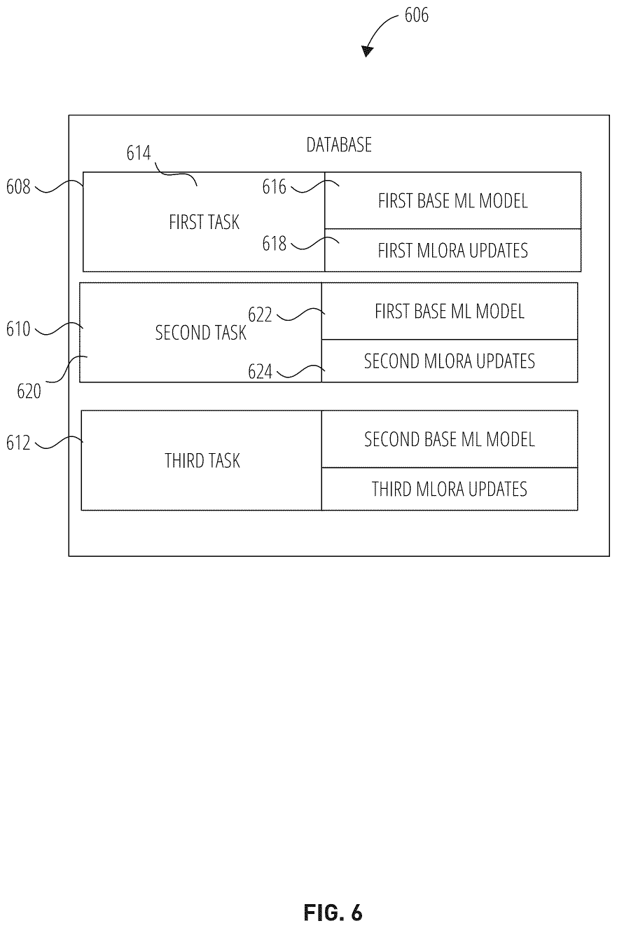

In some examples, the database 128 includes the ML model update database 606 of FIG. 6. The ML model update database 606 can include multiple entries storing associations between tasks, base ML models, and their corresponding parameter updates (e.g., mLoRA parameter updates). For example, a first entry 608 associates a first task identifier 614 with a first base ML model identifier 616 and a first mLoRA update identifier 618. Similarly, a second entry 610 associates a second task identifier 620 with a second base ML model identifier 622 and a second mLoRA update identifier 624. The database enables efficient lookup and retrieval of the appropriate base ML model and parameter updates when a user selects a particular task. When transitioning between tasks, the system can quickly determine which base ML model to load and which mLoRA updates to apply by referencing these stored associations. A third entry 612 associates a third task identifier with the second base ML model and third mLoRA updates.

For example, when a user selects an icon corresponding to a zebra stripe makeup effect digital effect on their user system 102, the system accesses the ML model update database 606 to retrieve the appropriate entries. The first task identifier 614 may correspond to a basic makeup effect like applying peach lipstick, which is associated with a first base ML model identifier 616 trained for facial feature manipulation and a first mLoRA update identifier 618 containing the specific parameters for the peach lipstick effect. When the user selects the zebra stripe effect icon, the user system 102 identifies a second task identifier 620 for the zebra pattern, retrieves the second base ML model identifier 622 (if different from the first base model), and accesses the second mLoRA update identifier 624 containing the minimal parameter changes needed to generate the zebra pattern overlay.

Similarly, if a user selects an icon to change eye color from blue to green, the database entries would associate this task with the appropriate base ML model trained for facial feature manipulation and the specific mLoRA updates for generating the green eye color effect. The user system 102 can also handle more complex digital effects. For example, when a user selects an icon for a professional makeup style transformation, the ML model update database 606 can link to a base model trained on makeup application patterns along with mLoRA updates containing the parameters for the specific professional style. In each case, the ML model update database 606 enables quick identification and retrieval of just the necessary ML model components and small parameter updates needed to efficiently switch between different digital effects tasks while maintaining the core understanding of facial feature manipulation.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences, such as that shown in ML model update database 606 of FIG. 6.

### Data Communications Architecture

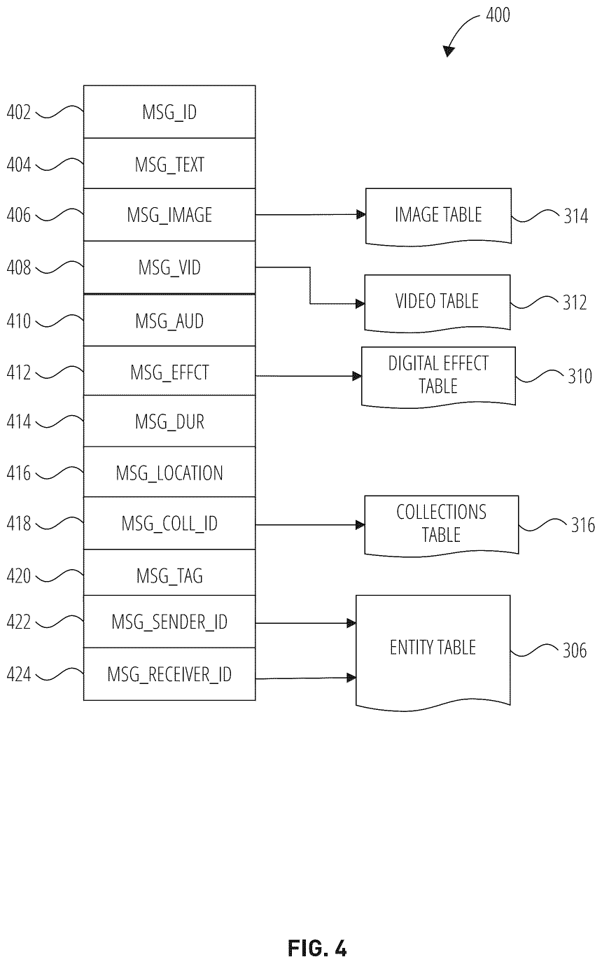

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

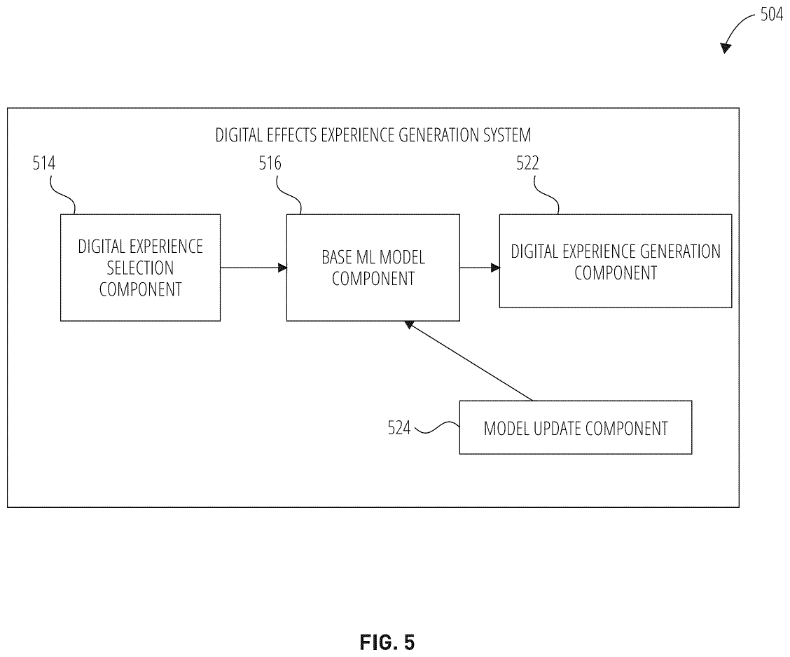

FIG. 5 illustrates a diagram of a digital effects experience generation system 504, according to some examples. The digital effects experience generation system 504 includes a digital experience selection component 514, a base ML model component 516, a digital experience generation component 522, and a model update component 524. Specifically, FIG. 5 illustrates a digital effects experience generation system 504 that enables efficient on-device ML model updates through several key components.

The base ML model component 516 is, in some examples, responsible for storing and managing the foundational ML models that are trained for specific domains. For example, in the image manipulation domain, a first base ML model is initially trained on multiple distinct tasks (e.g., ten different tasks) like applying different makeup effects, modifying facial features, and changing eye colors to establish core understanding of facial manipulation. The training process involves minimizing a specialized loss function that combines task-specific performance with rank minimization of weight matrices through singular value decomposition (SVD).

During the training phase, the base ML model component 516 works with the model update component 524 to analyze the SVD of weight matrices and determine the optimal ranks for parameter updates. This process identifies which parameters are most important for transitioning between different tasks while maintaining the model's fundamental capabilities. The resulting mLoRA parameter updates, representing less than 1% of the original model parameters, is stored in the ML model update database 606 along with their associations to specific tasks and base models. Namely, the foundational ML model (referred to as the base ML model) can then be fine-tuned on another sample from the same domain (e.g., 10 makeup styles different than those used to initially train the base ML model. In the process of fine-tuning the foundational ML model, parameters that are adapted/changed are tracked and used to generate the mLoRA update information for each sample in the new set of samples. This way, each sample in the new set of samples can be associated with the corresponding mLoRA weights. When the task corresponding to a particular one of the samples is selected, the foundational ML model (which is cached on the user system 102) can be updated using the corresponding mLoRA weights in order to train the model locally on the user system 102 to perform the task associated with the corresponding one of the samples.

Specifically, to fine-tune the base model while encouraging low-rank weights, the system minimizes the complement of the cumulative explained variance (EVR) across all singular values of the weight matrices. The equation used for this process is:

$$ℒ = {ℒ}_{task} + λ {\sum }_{i} ( 1 - \frac{{\sum }_{j = 1}^{{n}_{i}} {σ}_{ij}^{2}}{{total}_{i}} )$$

totalᵢ represents the total variance of Wᵢ (the weight matrix for the i-th layer of the base ML model), calculated as the sum of squared singular values, Lₜₐₛₖ refers to the task-specific loss (e.g., cross-entropy for classification), A is a regularization coefficient that controls the trade-off between task performance and rank minimization, Σᵢ represents the singular values of Wᵢ, sorted in descending order, and EVRi represents the cumulative explained variance for Wi, calculated as the sum of squared singular values divided by totalᵢ. The goal is to minimize 1−EVRi, which represents the portion of variance not captured by the singular values. This approach ensures that the weight matrices retain a low-rank structure, making them efficient for later LoRA decomposition. During training, the system processes each weight matrix through SVD analysis to calculate the explained variance, which quantifies the deviation from the base model and allows precise determination of the optimal rank for each matrix's Low-Rank Adaptation. Using the calculated LoRA ranks, an mLoRA is fine-tuned for each sample in the new set (e.g., the 10 different makeup styles). The result is a compact and task-specific parameter update optimized for mobile deployment that represents less than 1% of the original model parameters. These parameter updates are then stored in the ML model update database 606 along with their associations to specific tasks, enabling efficient retrieval and application when users select corresponding tasks on their devices.

The process for generating mLoRA parameters can begin with analyzing the base ML model's weight matrices (Wi) for each layer. For each weight matrix, the system first performs Singular Value Decomposition (SVD) to obtain the singular values (Ei), which are sorted in descending order to identify the most significant components of the matrix. The total variance (totalᵢ) for each weight matrix is calculated by summing the squares of all singular values in that layer. This provides a measure of the total information content contained within that layer's parameters. The cumulative explained variance ratio (EVRi) is then computed by taking the sum of squared singular values divided by the total variance, representing how much of the original information is captured by the most significant singular values.

During the fine-tuning process, the system combines two key components in its loss function: the task-specific loss (Ltask) which ensures the model maintains performance on the target task (like applying specific makeup effects), and a regularization term that encourages low-rank structure in the weight matrices. The regularization term specifically minimizes (1−EVRi), which represents the portion of variance not captured by the most significant singular values. The regularization coefficient (λ) controls how strongly the system enforces the low-rank constraint versus maintaining task performance. A larger λ value places more emphasis on achieving low-rank weight matrices, while a smaller value prioritizes task performance. This balance is important for generating efficient mLoRA updates that maintain effectiveness while minimizing parameter count.

For each new task in the training set (such as different makeup styles), the system processes the corresponding training samples through the model while optimizing this combined loss function. The optimization process gradually identifies which parameters are most important for adapting the base model to the new task while maintaining the low-rank constraint. The SVD analysis during training helps quantify how much each weight matrix deviates from the base model when adapting to new tasks. By analyzing these deviations, the system can determine the optimal rank for each matrix's Low-Rank Adaptation. This results in identifying how many parameters need to be modified to capture the task-specific variations.

Once the optimal ranks are determined, the system generates the mLoRA updates by extracting just the essential parameter modifications needed for each task. These updates are specifically designed to be compact, which can contain only the parameters corresponding to the most significant singular values identified during training. The resulting mLoRA updates are highly efficient, containing less than 1% of the parameters of the original model while still enabling effective task adaptation. For example, when training on different makeup styles, each style's mLoRA update captures just the essential parameters needed to modify the base model's behavior for that specific effect.

The system validates each generated mLoRA update to ensure it maintains task performance while achieving the desired parameter reduction. This includes verifying that the updated model can still effectively perform the target task when the mLoRA parameters are applied to the base model. Finally, the validated mLoRA updates are stored in the ML model update database 606 along with metadata linking them to their corresponding tasks and base models. This organization enables efficient retrieval and application of the correct parameter updates when users select specific tasks on their devices, allowing quick adaptation of the base model while maintaining minimal storage and transmission requirements.

In some examples, for the avatar animation domain, a second base ML model can be trained on tasks like generating synchronized lip movements and speech pattern processing. The system follows a similar training approach to create compact mLoRA updates for tasks like translating speech between languages or transforming emotional speaking styles. In the augmented reality effects domain, a third base ML model learns core capabilities for real-time scene understanding and digital overlay generation. The training process optimizes for efficient parameter updates that enable quick switching between different AR effects while maintaining consistent performance.

When a user selects a new task through the digital experience selection component 514, such as changing from peach lipstick to zebra stripe patterns, the digital effects experience generation system 504 identifies the required mLoRA updates from ML model update database 606. The model update component 524 then retrieves and applies these minimal parameter modifications to the cached base ML model. The digital experience generation component 522 processes inputs using the updated ML model to generate the desired effects. For example, when applying makeup effects, the digital experience generation component 522 processes facial images to create the selected style while maintaining natural appearance. For avatar animation, the digital experience generation component 522 generates synchronized lip movements and expressions that match the input speech patterns.

For example, when a user interacts with a graphical user interface on their user system 102, the user can select icons corresponding to different digital effects experiences. For example, when the user selects an icon to switch from a peach lipstick effect to a zebra stripe pattern overlay, the digital effects experience generation system 504 first checks if the appropriate base ML model is already cached on the user system 102. If not, the user system 102 identifies and loads the required base ML model from the ML model update database 606 by accessing the corresponding base ML model identifier (e.g., first base ML model identifier 616 or second base ML model identifier 622) associated with that task. The user system 102 can download the base ML model if not already available on the local storage and loads the base ML model into the cache.

Once the appropriate base ML model is loaded and cached, the user system 102 accesses the ML model update database 606 to retrieve the specific mLoRA update identifier (e.g., first mLoRA update identifier 618 or second mLoRA update identifier 624) containing the parameter modifications needed for the selected zebra stripe effect. The model update component 524 then retrieves the mLoRA parameters using the identifier from a remote server. The model update component 524 then applies these minimal parameter updates (retrieved from the remote server), which represent less than one percent of the original model parameters, to configure the cached base ML model for generating the new effect.

For example, when a user selects an icon to change eye color from blue to green, the database entries would associate this task with the appropriate base ML model trained for facial feature manipulation and the specific mLoRA updates for generating the green eye color effect. The system can also handle more complex digital effects. For example, when a user selects an icon for a professional makeup style transformation, the ML model update database can link to a base model trained on makeup application patterns along with mLoRA updates containing the parameters for the specific professional style. In each case, the ML model update database enables quick identification and retrieval of just the necessary ML model components and small parameter updates needed to efficiently switch between different digital effects tasks while maintaining the core understanding of facial feature manipulation.

The digital experience generation component 522 then processes inputs (such as facial images) using this updated model to generate the desired zebra stripe overlay effect while maintaining natural facial appearance and proper integration with the user's features. This same workflow applies whether processing makeup effects, avatar animations, or other digital effects. The system first ensures the appropriate base model is cached locally, retrieves and applies the minimal necessary parameter updates, and then generates the desired output using the updated model.

The model update component 524 continuously monitors performance and can make real-time adjustments to ensure optimal output quality. The model update component 524 works closely with the base ML model component 516 to maintain efficiency by only modifying a subset of parameters identified during training.

For brand messaging applications, the system can maintain consistent corporate communication styles by storing specialized mLoRA updates that capture company-specific speaking patterns and delivery characteristics. The model update component 524 applies these updates to ensure all generated content aligns with established brand standards. In the speech enhancement domain, the base model handles core speech processing capabilities while the mLoRA updates enable specific modifications like removing unclear patterns or adjusting emotional tone. The model update component 524 can apply these updates in real-time to improve speech quality while maintaining natural flow.

The digital experience generation component 522 supports integration with various output formats and environments. For AR applications, the digital experience generation component 522 can overlay generated effects on real-world video feeds. For avatar animation, the digital experience generation component 522 can incorporate the animated content into virtual environments or educational materials.

The digital effects experience generation system 504 maintains efficiency by storing only the base models locally while keeping the compact mLoRA updates in the ML model update database 606. This architecture enables quick task switching without requiring large model downloads or excessive storage space.

For real-time applications, the digital effects experience generation system 504 coordinates to process inputs and generate outputs with minimal latency. The model update component 524 ensures efficient parameter modifications without compromising performance. The digital effects experience generation system 504 supports privacy-conscious applications by performing all processing locally on the user system 102 using the cached base models. Only the compact parameter updates need to be transmitted over the network.

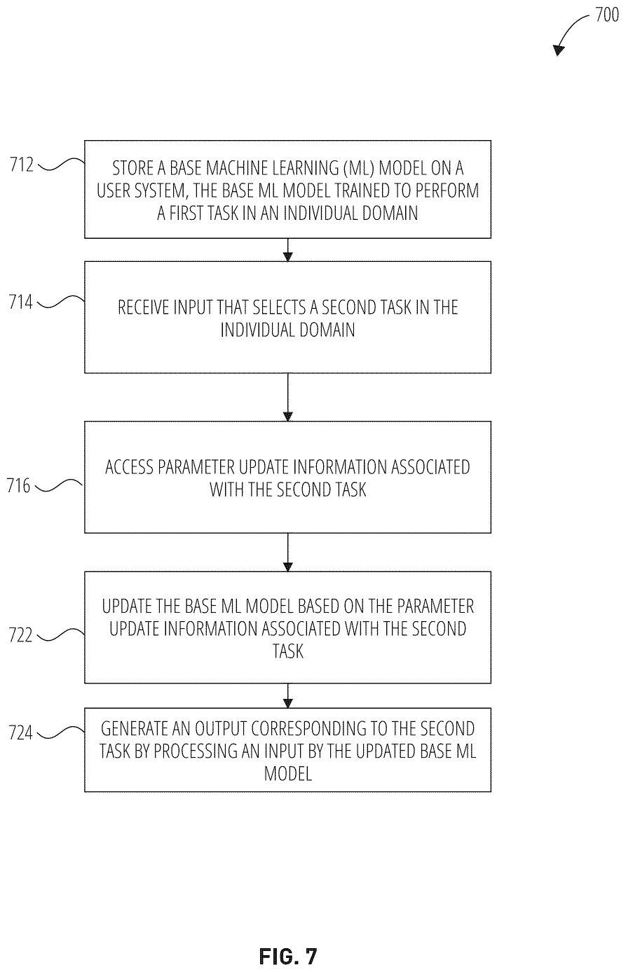

FIG. 7 is a flowchart illustrating routine 700 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 712, the digital effects experience generation system 504 stores a base machine learning (ML) model on a user system, the base ML model trained to perform a first task in an individual domain, as discussed above. Specifically, in operation 712, the base ML model component 516 stores a base ML model on the user system 102. For example, in the image manipulation domain, the base model is trained on approximately 10 distinct tasks like applying different makeup effects, modifying facial features, and changing eye colors to establish core understanding of facial manipulation. The base ML model component 516 works with the model update component 524 during training to analyze SVD of weight matrices and determine optimal ranks for parameter updates.

In operation 714, the digital effects experience generation system 504 receives input that selects a second task in the individual domain, as discussed above. Namely, when a user interacts with a graphical user interface on their user system 102, the user can select icons corresponding to different digital effects experiences. For example, when the user selects an icon to switch from a peach lipstick effect to a zebra stripe pattern overlay, the digital effects experience generation system 504 receives this selection input. The digital experience selection component 514 processes the user's selection of the new task.

In operation 716, the digital effects experience generation system 504 accesses parameter update information associated with the second task, as discussed above. For example, the digital effects experience generation system 504 accesses the ML model update database 606 to retrieve the specific mLoRA update identifier (e.g., first mLoRA update identifier 618 or second mLoRA update identifier 624) containing the parameter modifications needed for the selected task. For example, if a user selects an icon to change eye color from blue to green, the database entries would associate this task with the appropriate base ML model trained for facial feature manipulation and the specific mLoRA updates for generating the green eye color effect.

In operation 722, the digital effects experience generation system 504 updates the base ML model based on the parameter update information associated with the second task, as discussed above. The model update component 524 applies the minimal parameter updates, which represent less than one percent of the original model parameters, to configure the cached base ML model for generating the new effect. For example, when transitioning from peach lipstick to zebra stripes, the system processes these small parameter modifications to configure the base model while maintaining its fundamental understanding of facial features and digital effects processing.

In operation 724, the digital effects experience generation system 504 generates an output corresponding to the second task by processing an input by the updated base ML model, as discussed above. Namely, the digital experience generation component 522 processes inputs using the updated model to generate the desired effects. For example, when applying makeup effects, it processes facial images to create the selected style while maintaining natural appearance. For avatar animation, it generates synchronized lip movements and expressions that match the input speech patterns. The digital experience generation component 522 can continuously process real-time inputs to update animations and effects based on changing conditions or user interactions.

System with Head-Wearable Apparatus

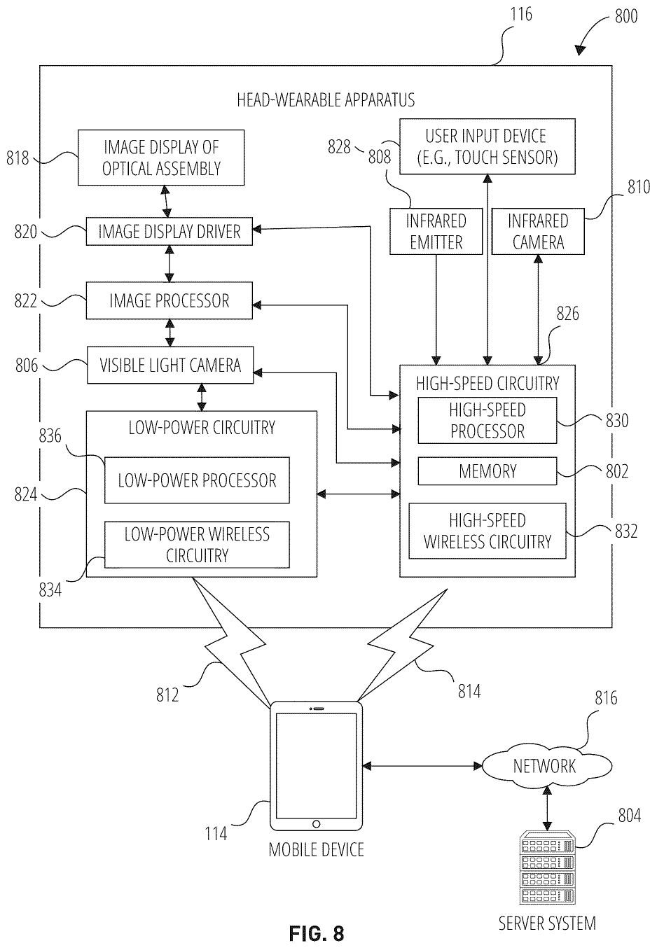

FIG. 8 illustrates a system 800 including a head-wearable apparatus 116 with a selector input device, according to some examples. FIG. 8 is a high-level functional block diagram of an example head-wearable apparatus 116 communicatively coupled to a mobile device 114 and various server systems 804 (e.g., the server system 110) via various networks.

The head-wearable apparatus 116 includes one or more cameras, each of which may be, for example, a visible light camera 806, an infrared emitter 808, and an infrared camera 810.

The mobile device 114 connects with head-wearable apparatus 116 using both a low-power wireless connection 812 and a high-speed wireless connection 814. The mobile device 114 is also connected to the server system 804 and the network 816.

The head-wearable apparatus 116 further includes two image displays of the image display of optical assembly 818. The two image displays of optical assembly 818 include one associated with the left lateral side and one associated with the right lateral side of the head-wearable apparatus 116. The head-wearable apparatus 116 also includes an image display driver 820, an image processor 822, low-power circuitry 824, and high-speed circuitry 826. The image display of optical assembly 818 is for presenting images and videos, including an image that can include a graphical user interface to a user of the head-wearable apparatus 116.

The image display driver 820 commands and controls the image display of optical assembly 818. The image display driver 820 may deliver image data directly to the image display of optical assembly 818 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 828 (e.g., touch sensor or push button), including an input surface on the head-wearable apparatus 116. The user input device 828 (e.g., touch sensor or push button) is to receive from the user an input selection to manipulate the graphical user interface of the presented image.

The components shown in FIG. 8 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 806 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 802, which stores instructions to perform a subset, or all the functions described herein. The memory 802 can also include storage device.

As shown in FIG. 8, the high-speed circuitry 826 includes a high-speed processor 830, a memory 802, and high-speed wireless circuitry 832. In some examples, the image display driver 820 is coupled to the high-speed circuitry 826 and operated by the high-speed processor 830 to drive the left and right image displays of the image display of optical assembly 818. The high-speed processor 830 may be any processor capable of managing high-speed communications and operation of any general computing system needed for the head-wearable apparatus 116. The high-speed processor 830 includes processing resources needed for managing high-speed data transfers on a high-speed wireless connection 814 to a wireless local area network (WLAN) using the high-speed wireless circuitry 832. In certain examples, the high-speed processor 830 executes an operating system such as a LINUX operating system or other such operating system of the head-wearable apparatus 116, and the operating system is stored in the memory 802 for execution. In addition to any other responsibilities, the high-speed processor 830 executing a software architecture for the head-wearable apparatus 116 is used to manage data transfers with high-speed wireless circuitry 832. In certain examples, the high-speed wireless circuitry 832 is configured to implement Institute of Electrical and Electronic Engineers (IEEE) 802.11 communication standards, also referred to herein as WI-FI®. In some examples, other high-speed communications standards may be implemented by the high-speed wireless circuitry 832.

The low-power wireless circuitry 834 and the high-speed wireless circuitry 832 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 812 and the high-speed wireless connection 814, may be implemented using details of the architecture of the head-wearable apparatus 116, as can other elements of the Network 816.

The memory 802 includes any storage device capable of storing various data and applications, including, among other things, camera data generated by the left and right visible light cameras 806, the infrared camera 810, and the image processor 822, as well as images generated for display by the image display driver 820 on the image displays of the image display of optical assembly 818. While the memory 802 is shown as integrated with high-speed circuitry 826, in some examples, the memory 802 may be an independent standalone element of the head-wearable apparatus 116. In certain such examples, electrical routing lines may provide a connection through a chip that includes the high-speed processor 830 from the image processor 822 or the low-power processor 836 to the memory 802. In some examples, the high-speed processor 830 may manage addressing of the memory 802 such that the low-power processor 836 will boot the high-speed processor 830 any time that a read or write operation involving memory 802 is needed.

As shown in FIG. 8, the low-power processor 836 or high-speed processor 830 of the head-wearable apparatus 116 can be coupled to the camera (visible light camera 806, infrared emitter 808, or infrared camera 810), the image display driver 820, the user input device 828 (e.g., touch sensor or push button), and the memory 802.

The head-wearable apparatus 116 is connected to a host computer. For example, the head-wearable apparatus 116 is paired with the mobile device 114 via the high-speed wireless connection 814 or connected to the server system 804 via the Network 816. The server system 804 may be one or more computing devices as part of a service or network computing system, for example, that includes a processor, a memory, and network communication interface to communicate over the Network 816 with the mobile device 114 and the head-wearable apparatus 116.

The mobile device 114 includes a processor and a network communication interface coupled to the processor. The Network communication interface allows for communication over the Network 816, low-power wireless connection 812, or high-speed wireless connection 814. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 820. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 804, such as the user input device 828, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 812 and high-speed wireless connection 814 from the mobile device 114 via the low-power wireless circuitry 834 or high-speed wireless circuitry 832.

### Machine Architecture

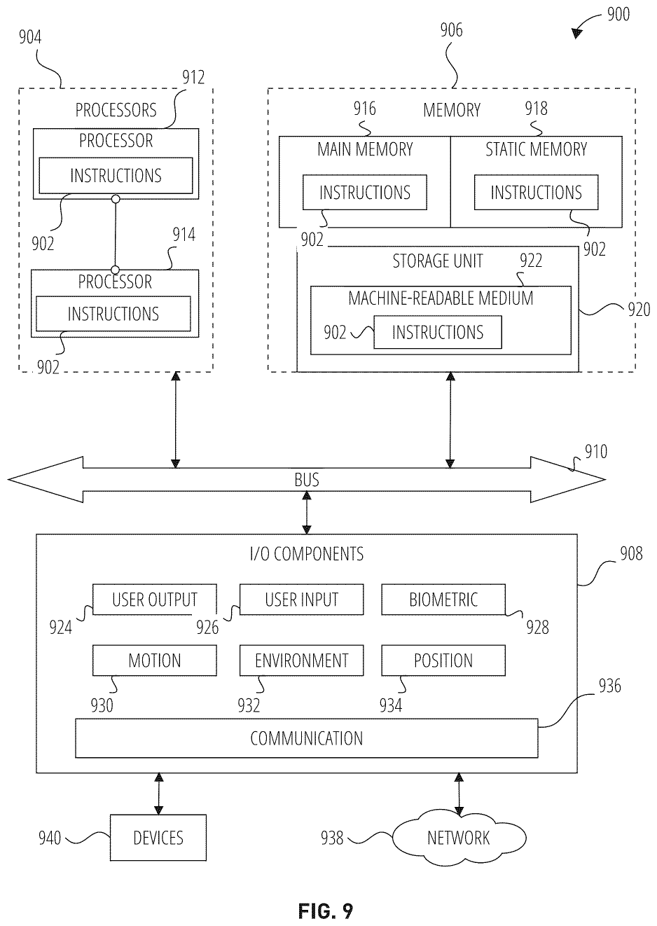

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the server system 110. In some examples, the machine 900 may also comprise both client and server systems, with certain operations of a particular method or algorithm being performed on the server-side and with certain operations of the method or algorithm being performed on the client-side.

The machine 900 may include processors 904, memory 906, and input/output I/O components 908, which may be configured to communicate with each other via a bus 910.

The memory 906 includes a main memory 916, a static memory 918, and a storage unit 920, both accessible to the processors 904 (e.g., processor 912 or processor 914 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the Processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 908 further include communication components 936 operable to couple the machine 900 to a Network 938 or devices 940 via respective coupling or connections. For example, the communication components 936 may include a network interface component or another suitable device to interface with the Network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the Processors 904) and storage unit 920 may store one or more sets of instructions and data structures (e.g., software) embodying or used by any one or more of the methodologies or functions described herein. These instructions (e.g., the instructions 902), when executed by Processors 904, cause various operations to implement the disclosed examples.

The instructions 902 may be transmitted or received over the Network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

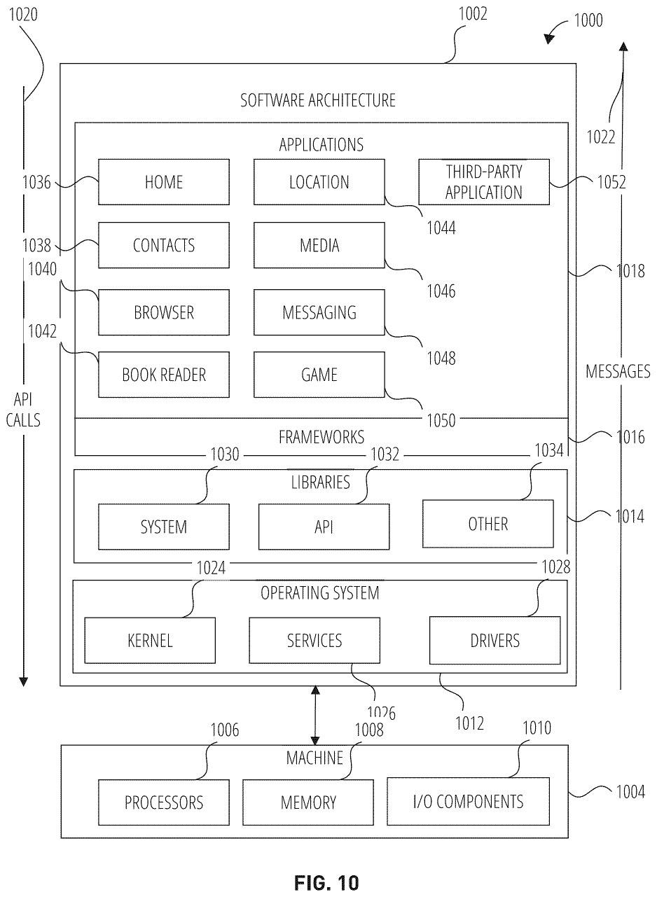

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: storing a base machine learning (ML) model on a user system, the base ML model trained to perform a first task in an individual domain; receiving input that selects a second task in the individual domain; accessing parameter update information associated with the second task; updating the base ML model based on the parameter update information associated with the second task; and generating an output corresponding to the second task by processing an input by the updated base ML model.

Example 2. The system of Example 1, wherein the individual domain comprises a plurality of image manipulation tasks.

Example 3. The system of Example 2, wherein the plurality of image manipulation tasks comprises applying different digital effects to one or more images comprising the input.

Example 4. The system of any one of Examples 1-3, wherein the parameter update information comprises less than one percent of parameters of the base ML model.

Example 5. The system of any one of Examples 1-4, wherein the parameter update information comprises a mobile Low-Rank Adaptation (mLoRA) update.

Example 6. The system of any one of Examples 1-5, wherein the base ML model is trained on a collection of distinct tasks within the individual domain comprising the first task.

Example 7. The system of any one of Examples 1-6, wherein the operations comprise training the base ML model by performing training operations comprising: minimizing a loss function that combines task-specific loss with rank minimization of weight matrices.

Example 8. The system of Example 7, wherein the training operations for minimizing the loss function comprise: calculating singular values of weight matrices; and minimizing a complement of cumulative explained variance across the singular values.

Example 9. The system of any one of Examples 1-8, wherein the operations further comprise: analyzing singular value decomposition (SVD) of weight matrices to determine ranks for parameter updates.

Example 10. The system of any one of Examples 1-9, wherein the operations further comprise: storing the parameter update information in a remote server.

Example 11. The system of any one of Examples 1-10, wherein the second task is excluded from tasks that the base ML model has been trained to perform.

Example 12. The system of any one of Examples 1-11, wherein the operations further comprise: determining a set of parameters of the base ML model to modify based on analyzing changes associated with transitions from performing the first task to performing the second task.

Example 13. The system of any one of Examples 1-12, wherein the parameter update information is selected from a pre-generated collection of parameter updates.

Example 14. The system of any one of Examples 1-13, wherein the operations comprise: iteratively generating parameter updates for multiple tasks within the individual domain.

Example 15. The system any one of Examples 1-14, wherein the first task comprises a first digital effect, and wherein the second task comprises a second digital effect.

Example 16. The system of any one of Examples 1-15, wherein the base ML model comprises a first base ML model, and wherein the operations comprise: associating a first digital effect with the first base ML model and a first set of parameter update information; associating a second digital effect with a second base ML model and a second set of parameter update information; determining that the second task corresponds to the second digital effect; loading the second base ML model associated with the second digital effect into memory of the user system; and retrieving the second set of parameter update information for the second digital effect after loading the second base ML model.

Example 17. The system of Example 16, wherein the operations comprise: modifying a subset of parameters of the second base ML model based on the second set of parameter update information to configure the second base ML model to perform the second task.

Example 18. The system of any one of Examples 1-17, wherein the first task and the second task share a common underlying representation within the individual domain.

Example 19. A computer-implemented method comprising: storing, by one or more processors, a base ML model on a user system, the base ML model trained to perform a first task in an individual domain; receiving input that selects a second task in the individual domain; accessing parameter update information associated with the second task; updating the base ML model based on the parameter update information associated with the second task; and generating an output corresponding to the second task by processing an input by the updated base ML model.

Example 20. A non-transitory computer-readable storage medium storing instructions that, when executed by at least one processor, cause the at least one processor to perform operations comprising: storing a base ML model on a user system, the base ML model trained to perform a first task in an individual domain; receiving input that selects a second task in the individual domain; accessing parameter update information associated with the second task; updating the base ML model based on the parameter update information associated with the second task; and generating an output corresponding to the second task by processing an input by the updated base ML model.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
storing a base machine learning (ML) model on a user system, the base ML model trained to perform a first task in an individual domain;
receiving input that selects a second task in the individual domain;
accessing parameter update information associated with the second task;
updating the base ML model based on the parameter update information associated with the second task; and
generating an output corresponding to the second task by processing an input by the updated base ML model.

2. The system of claim 1, wherein the individual domain comprises a plurality of image manipulation tasks.

3. The system of claim 2, wherein the plurality of image manipulation tasks comprises applying different digital effects to one or more images comprising the input.

4. The system of claim 1, wherein the parameter update information comprises less than one percent of parameters of the base ML model.

5. The system of claim 1, wherein the parameter update information comprises a mobile Low-Rank Adaptation (mLoRA) update.

6. The system of claim 1, wherein the base ML model is trained on a collection of distinct tasks within the individual domain comprising the first task.

7. The system of claim 1, wherein the operations comprise training the base ML model by performing training operations comprising:
minimizing a loss function that combines task-specific loss with rank minimization of weight matrices.

8. The system of claim 7, wherein the training operations for minimizing the loss function comprise:
calculating singular values of weight matrices; and
minimizing a complement of cumulative explained variance across the singular values.

9. The system of claim 1, wherein the operations further comprise:
analyzing singular value decomposition (SVD) of weight matrices to determine ranks for parameter updates.

10. The system of claim 1, wherein the operations further comprise:
storing the parameter update information in a remote server.

11. The system of claim 1, wherein the second task is excluded from tasks the base ML model has been trained to perform.

12. The system of claim 1, wherein the operations further comprise:
determining a set of parameters of the base ML model to modify based on analyzing changes associated with transitions from performing the first task to performing the second task.

13. The system of claim 1, wherein the parameter update information is selected from a pre-generated collection of parameter updates.

14. The system of claim 1, wherein the operations comprise:
iteratively generating parameter updates for multiple tasks within the individual domain.

15. The system of claim 1, wherein the first task comprises a first digital effect, and wherein the second task comprises a second digital effect.

16. The system of claim 1, wherein the base ML model comprises a first base ML model, and wherein the operations comprise:
associating a first digital effect with the first base ML model and a first set of parameter update information;
associating a second digital effect with a second base ML model and a second set of parameter update information;
determining that the second task corresponds to the second digital effect;
loading the second base ML model associated with the second digital effect into memory of the user system; and
retrieving the second set of parameter update information for the second digital effect after loading the second base ML model.

17. The system of claim 16, wherein the operations comprise:
modifying a subset of parameters of the second base ML model based on the second set of parameter update information to configure the second base ML model to perform the second task.

18. The system of claim 1, wherein the first task and the second task share a common underlying representation within the individual domain.

19. A computer-implemented method comprising:
storing, by one or more processors, a base machine learning (ML) model on a user system, the base ML model trained to perform a first task in an individual domain;
receiving input that selects a second task in the individual domain;
accessing parameter update information associated with the second task;
updating the base ML model based on the parameter update information associated with the second task; and
generating an output corresponding to the second task by processing an input by the updated base ML model.

20. A non-transitory computer-readable storage medium storing instructions that, when executed by at least one processor, cause the at least one processor to perform operations comprising:
storing a base machine learning (ML) model on a user system, the base ML model trained to perform a first task in an individual domain;
receiving input that selects a second task in the individual domain;
accessing parameter update information associated with the second task;
updating the base ML model based on the parameter update information associated with the second task; and
generating an output corresponding to the second task by processing an input by the updated base ML model.
